(19) United States
(12) Patent Application Publication
(10) Pub. No.: US 2011/0172024 A1
(43) Pub. Date: Jul. 14, 2011

(54) GRIP FOR SPORTING EQUIPMENT

(76) Inventor: Clive S. Lu, Hicksville, NY (US)

(21) Appl. No.: 13/072,073

(22) Filed: Mar. 25, 2011

Related U.S. Application Data
(63) Continuation-in-part of application No. 13/012,396, filed on Jan. 24, 2011.
Application No. 13/012,396 is a continuation-in-part of application No. 12/410,973, filed on Mar. 25, 2009.

(51) Int. Cl. A63B 53/14; B23P 11/00

(52) U.S. Cl. 473/300; 29/428

(57) ABSTRACT

A grip for sporting equipment having a gripping end includes a base having a hollow interior defining a gripping end receiver and an exterior surface including at least one cavity defined in least a portion of a thickness thereof. At least one insert defining an exterior perimeter substantially coincident with an interior perimeter of the at least one cavity is provided. The at least one cavity is defined in less than a full circumference of the base exterior surface. When assembled, the at least one insert, the at least one cavity, and the base exterior surface define at least one of a substantially flush top surface, a raised surface, and an indented surface, and likewise define a decorative, informational, or functional design disposed on the base exterior surface. In turn, items of sporting equipment and methods for providing grips for sporting equipment are described.

This application claims priority as a continuation-in-part of U.S. utility patent application serial no. 13/012,396 filed on Jan. 24, 2011, which in turn is a continuation-in-part of U.S. utility patent application Ser. No. 12/410,973 filed on Mar. 25, 2009, the disclosures of each of which are incorporated herein in their entirety by reference.

### FIELD OF THE INVENTION

This disclosure relates generally to the field of grips for articles of sporting equipment having a gripping end, such as golf clubs and tennis rackets. In particular, the present disclosure relates to grips for incorporating one or more layers of material for displaying a decorative, textured, or informational design, and to methods for securing such layers to a grip. Still further, the disclosure relates to such grips including inserts for providing decorative, informational, or functional designs.

### BACKGROUND OF THE INVENTION

The grip provided on most sporting equipment having a gripping end, such as golf clubs, tennis rackets, and the like, provides cushioning and reduces slippage of the user's hands, thereby improving the user's enjoyment of the sport of choice. As illustrated in FIG. 1, to provide the desired cushioned, reduced slippage surface for gripping, a grip 100 for such sporting equipment sometimes takes the form of a single, solid piece 120 with a hollow interior 110 that fits over an end of the gripping end 12. In an alternative embodiment, a grip 200 for such sporting equipment may comprise a grip base 210 (often referred to as an “underlisting”) and an overlapping cushioning layer 220, as shown in FIGS. 2a and 2b. The grip base 210 has ends 230 and 240 and may be slipped or rolled onto the gripping end 12, and the cushioning layer 220 may be wrapped around the grip base 210. Information regarding the equipment, such as a logo indicating the source of the goods, or a decorative design, may be displayed on the cushioning layer 220 of the grip.

The manufacturer may desire to display a design on the equipment, such as a corporate logo(s) and/or information regarding the equipment (make, model, size, etc.). Alternatively, the user may desire such a design for decorative purposes, to identify the equipment as belonging to the user, and the like.

Also, users desire large grips, for example, to accommodate the user's hand size and prevent the overlapping of the user's hands. As an example, it is well known to provide an oversized putter grip. However, increasing the size of the grip by simply increasing the thickness of, for example, the base 210 and/or a cushioning layer 220 undesirably greatly increases the weight of the grip as well, which may inhibit the user's performance in the sport of choice.

Accordingly, there remains a need in the art for grips including layers of materials, such as cushioning layers, design sheets, inserts, and/or combinations thereof, to provide grips of varying physical properties and optionally including designs which impart information, are decorative, and/or provide an additional functionality to the grip. Desirably, this is done in a fashion which does not significantly increase the assembled grip weight.

### SUMMARY OF THE INVENTION

In accordance with the need identified in the art, in one aspect the present disclosure describes a grip for sporting equipment having a gripping end, comprising a grip base or underlisting adapted to receive the gripping end in an interior thereof. The grip base or underlisting may include at least one cavity defined in an exterior surface thereof, and configured to receive a layer of material, an insert, or the like therein. The interior perimeter of the cavity and the exterior perimeter of the layer of material, the insert, or the like may be substantially coincident. The insert or inserts may include a design of a decorative, textured, or informational nature. In another embodiment, the cavities and cooperating inserts may be disposed on the exterior surface of the grip base to define a decorative, informational, or functional design.

The grip base may define opposed grip end portions and a center portion, with each grip end portion defining a receiver adapted for receiving at least a portion of one or more layers substantially overlaying the center portion. Typically, the grip end portions will be fabricated of a durable material for protecting the at least one grip end from damage and may extend various lengths along the gripping end. The center portion and grip ends may define or partially define a portion of the at least one cavity.

The grip end portions and center portion may be separate elements, or may be a unitary construction. The center portion will typically define a cross section that is narrower or thinner than, for example, the one-piece grip shown in FIG. 1, to accommodate various overlaying layers of material of differing thicknesses and/or weights. In embodiments wherein the grip end portions and center portion are separate elements, it will be appreciated that the grip end portions may be attached to the center portion using any method of attachment known in the art, for example, a friction fit, a snap fit, an adhesive, any combination of adhesive and the aforementioned fittings, and the like. In embodiments wherein the grip end portions and center portion are a unitary construction, the grip end portions and the center portion may be formed or molded as a single unit using any method of formation or molding known in the art, for example, injection molding, compression molding, extrusion molding, casting, and the like.

Any suitable adhesive as is known in the art may be used to affix the grip base to the gripping end, to affix the one or more layers to the center portion and to affix the one or more layers to one another. Also or in the alternative, the center portion and the one or more layers may be manufactured of compatible materials such that heat and pressure bond them together.

Any material having the desired properties, such as where appropriate particular properties of durability, thickness, strength, shock absorption, cushioning, tackiness, and aesthetically pleasing appearance may be used in fabricating the grip base and the at least one insert. A number of suitable materials are well known in the art and are contemplated for use herein, such without intending any limitation as rubber, polymers, latex, natural or synthetic leathers, closed cell foams, open cell foams, natural material, synthetic material, or any other material currently used in fabricating grips for sports equipment.

Certain of the one or more layers/inserts overlaid on the grip base and/or placed in the at least one cavity may take any of a variety of forms, such as a hollow sleeve or cylinder, a planar sheet or block having two side edges, a top edge, and a bottom edge, or the like. Again, any material having the desired properties, such as where appropriate durability, thickness, strength, cushioning, shock absorption, tackiness, and aesthetically pleasing appearance may be used in fabricating any of the one or more layers/inserts, such as without intending any limitation polymers, closed cell foams, open cell foams, latex, rubber, natural or synthetic leathers, natural material, synthetic material, or any other material currently used in fabricating grips for sports equipment. A variety of such materials are well known in the art.

In addition, any of the one or more layers/inserts may be fabricated of any suitable lightweight material, such as without intending any limitation closed cell foams, open cell foams, polymers, or synthetic materials. As will be appreciated, the thickness of the layers/inserts formed of such a lightweight material may be increased without greatly increasing the weight of the grip, thereby allowing significant increases in the cross-sectional diameter of the grip without greatly increasing the weight of the grip. Any of the one or more layers/inserts, such as a layer to be disposed on top of any other layers attached to the grip base, may be fabricated of a suitable substantially transparent material to provide a protective surface for a design placed on the gripping surface while still allowing visualization of the design.

The grip end portions may include or define receivers adapted to receive at least a portion of at least one of the one or more layers, including but not limited to a flange, rim, projecting edge, lip, slant, groove, bevel, channel, slot, slit, notch, and the like. Advantageously, the receivers assist in preventing the leakage of adhesive from an area between the center portion and the one or more layers as well as from areas between the one or more layers. In addition, the receivers assist in protecting at least a portion of opposed edges of the one or more layers/inserts attached to the grip base from damage.

Still other aspects of the present invention will become apparent to those skilled in this art from the following description wherein there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawings incorporated in and forming a part of the specification illustrate several aspects of the present invention and, together with the description, serve to explain the principles of the invention. In the drawings:

FIG. 1 is a perspective view of a prior art grip formed of a single, solid piece of material;

FIG. 2a is a perspective view of a prior art grip having a hollow cylinder and an overlapping cushioning layer;

FIG. 2b shows an exploded view of the prior art grip of FIG. 2a having a hollow cylinder and an overlapping cushioning layer;

FIG. 3 is an exploded view of an embodiment of the grip of the present invention, having grip end portions, a center portion, and layers, including a cushioning layer and a transparent layer, for overlaying the center portion;

FIG. 4 shows a side cross-sectional view of the grip of FIG. 3;

FIG. 5 shows a perspective view of the grip of FIGS. 3 and 4 installed on a gripping end of sporting equipment;

FIG. 6 is an exploded view of another embodiment of the grip of the present invention, having grip end portions, a center portion, and layers, including a lightweight layer and a transparent layer, for overlaying the center portion;

FIG. 7 shows a side cross-sectional view of the grip of FIG. 6;

FIG. 8 shows a perspective view of the grip of FIGS. 6 and 7 installed on a gripping end of sporting equipment;

FIG. 9 is a side cross-sectional view of another embodiment of the grip of the present invention, having grip end portions, a center portion, and layers, including a lightweight layer, a cushioning layer, and a transparent layer, for overlaying the center portion;

FIGS. 10a-10c show different embodiments of the grip end portion receivers of the grip of FIG. 4;

FIG. 11 shows an exploded view of a grip base and insert according to the present disclosure;

FIG. 12 is a perspective view of the assembled grip of FIG. 11;

FIGS. 13a-c show alternative embodiments of grip base cavities and inserts according to the disclosure;

FIGS. 14a-b show alternative embodiments of retention systems for the grip base cavities and inserts according to the disclosure;

FIG. 15 shows in cutaway view a substantially transparent or translucent insert according to the present disclosure, including a design disposed on a bottom surface thereof; and

FIG. 16 shows a top view of a design placed on an exterior surface of a grip base using inserts.

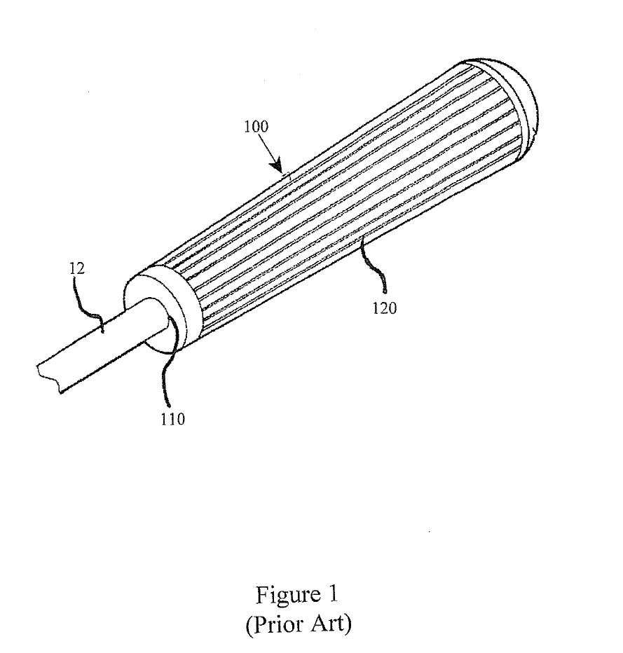

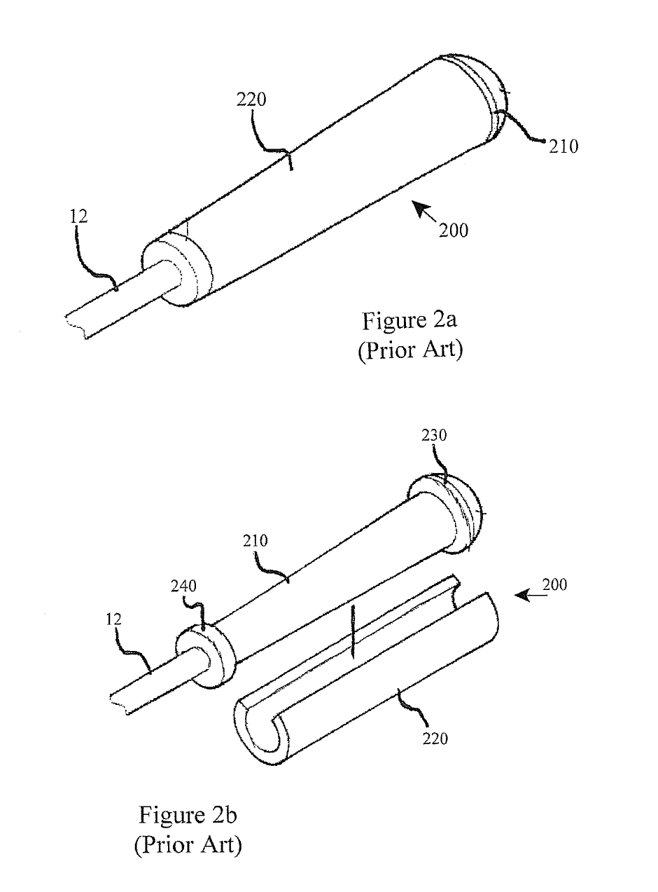

Reference will now be made in detail to the presently preferred embodiment of the invention, an example of which is illustrated in the accompanying drawings. In those drawings, for convenience, like features are labeled with like reference numerals.

### DETAILED DESCRIPTION OF THE INVENTION

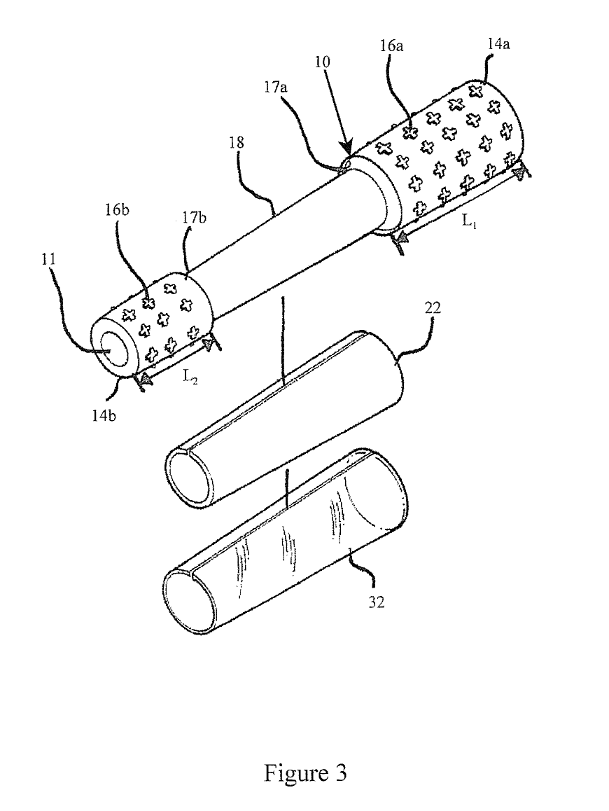

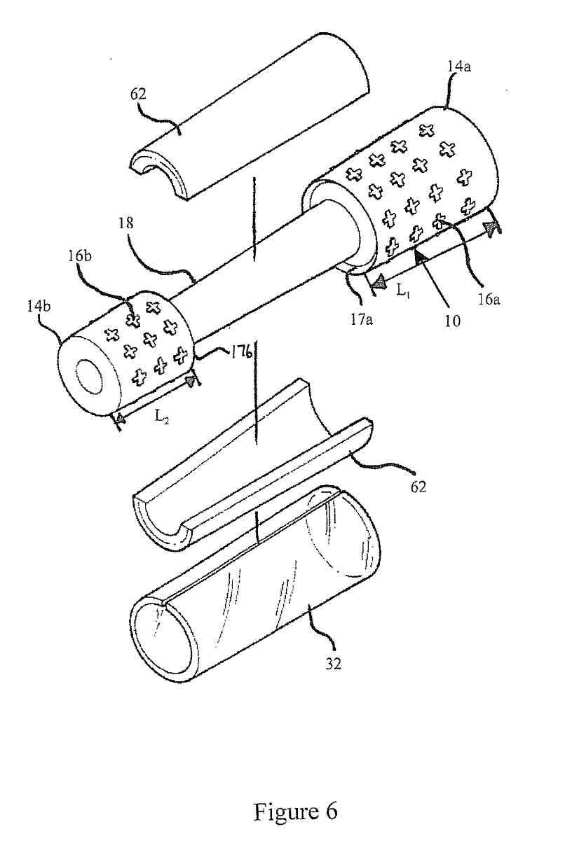

In one aspect, the present disclosure provides a grip base 10 for sporting equipment having a gripping end. As illustrated in FIGS. 3 and 6, the grip base 10 comprises grip ends 14a and 14b, grip end portions 16a and 16b, and a center portion 18. The grip end portions 16a and 16b extend by lengths L₁ and L₂, respectively, from the grip ends 14a and 14b, respectively. The grip end portions 16a and 16b may be fabricated of a durable material for protecting the grip ends 14a and 14b from damage.

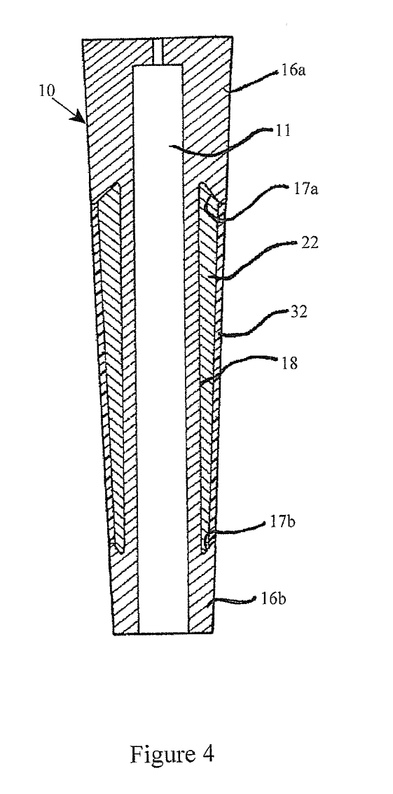

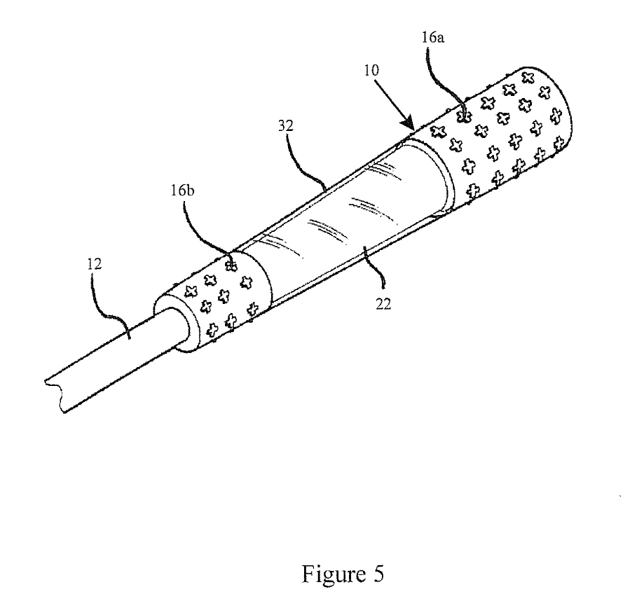

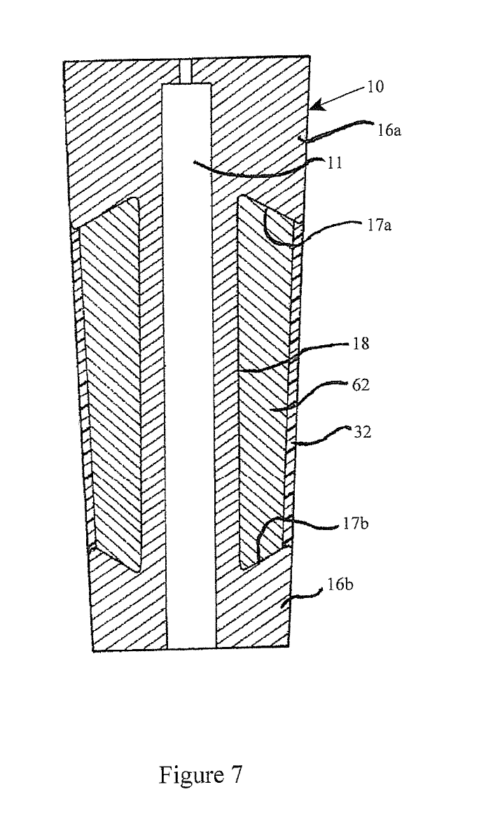

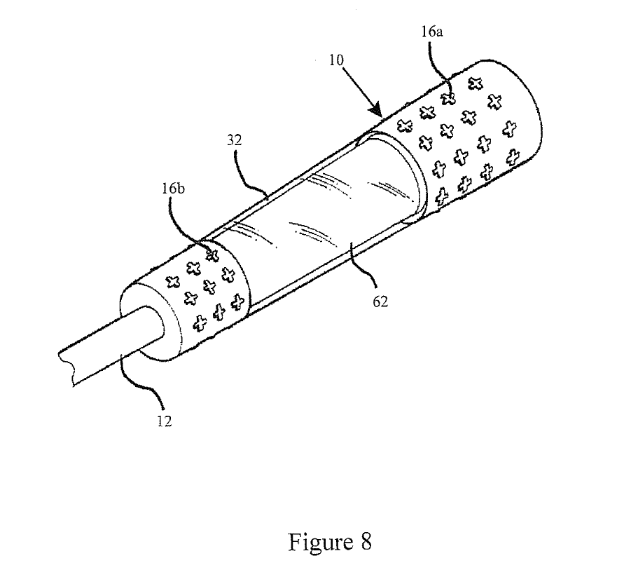

The center portion 18 is located between the grip end portions 16a and 16b and is adapted for receiving the gripping end 12 in an interior thereof, as shown in FIGS. 5 and 8. The grip end portions 16a and 16b are also adapted for receiving the gripping end 12 in an interior 11 thereof. Turning to FIGS. 4 and 7, the grip end portions 16a and 16b define receivers 17a and 17b, respectively. In combination, the center portion 18 and the receivers 17a and 17b define an area to which one or more layers of material may be applied and attached to center portion 18 of the grip 10.

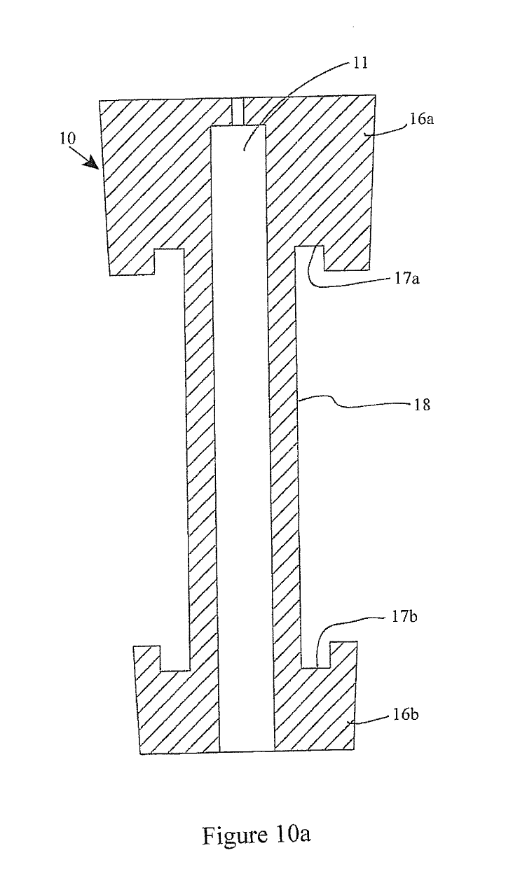

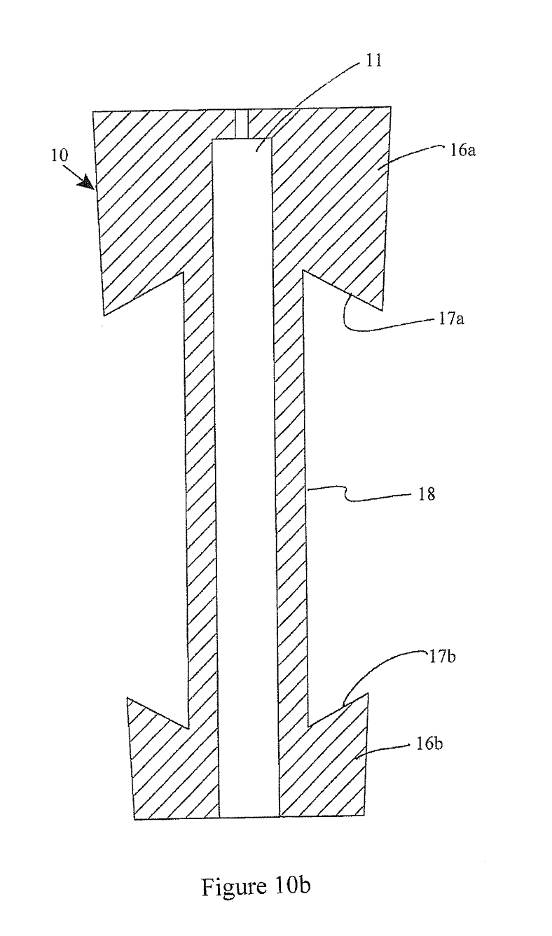

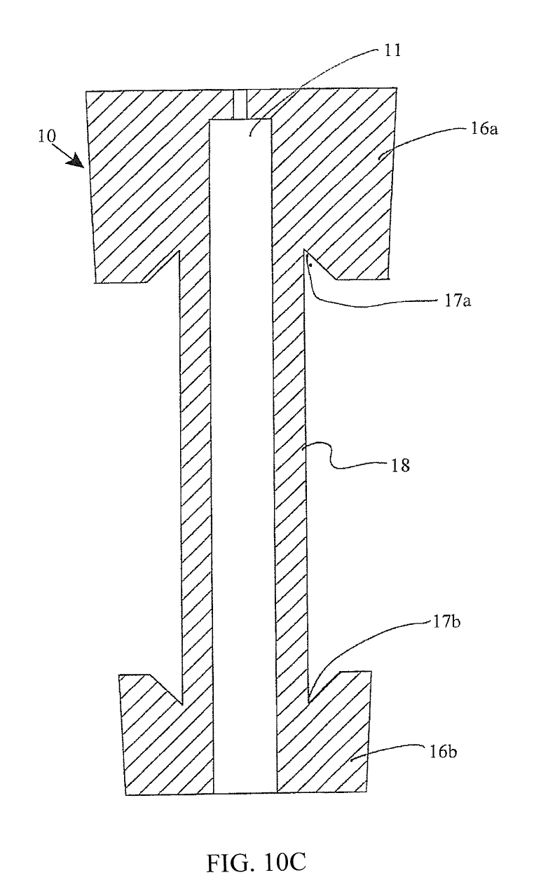

The receivers 17a and 17b may be adapted to receive a first layer of material, such as a layer 22 or 62, disposed over the center portion. In this manner, the receivers 17a and 17b assist in protecting opposed edges of the first layer from damage. The receivers 17a and 17b may take any form suitable to receive the first layer. Exemplary forms of the receivers 17a and 17b include, without limitation, a flange, rim, projecting edge, lip, slant, groove, bevel, channel, slot, slit, or notch. Non-limiting examples of embodiments of receivers 17a and 17b are shown in FIGS. 10a-10c. The first layer may also take any of a variety of forms, such as a hollow sleeve or cylinder, a planar sheet having two side edges, a top edge, and a bottom edge, or the like. A second layer of material, such as a layer 32, may also be disposed over the first layer, and the receivers 17a and 17b may be adapted also to receive the second layer. Accordingly, the receivers 17a and 17b may also assist in protecting opposed ends of the second layer from damage.

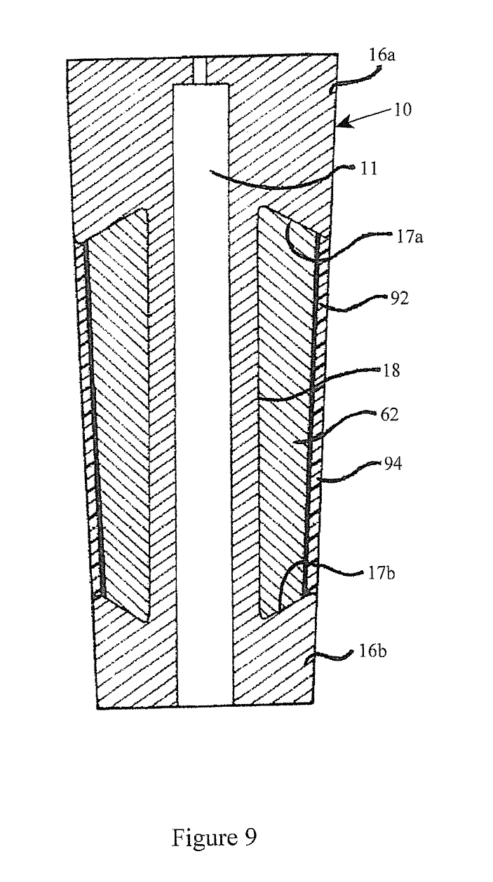

As illustrated in FIG. 9, a third layer, such as a layer 94, may be disposed over the second layer, such as a layer 92, and the second layer may be disposed over the first layer, such as a layer 62. The receivers 17a and 17b may be adapted also to receive the third layer. It will be appreciated that multiple additional layers could be disposed over first, second, and third layers, in accordance with the needs and desires of the user, i.e. in accordance with the desired properties of cushioning, aesthetics, thickness or diameter, durability, tackiness, etc.

By selecting materials which provide the desired properties and applying same in multiple layers rather than as single solid pieces or fewer layers as conventionally done in the art, it is possible to provide a grip having desired properties without significantly increasing total weight. As a non-limiting example, a first layer 22 could be selected for a desirable property of durability, a second layer 32 could be selected for a desirable property of cushioning, and a third layer 94 could be selected for a desirable property of tackiness. By using these three layers, rather than a grip formed of a single piece of material or an underlisting and a single thick layer of material wrapped around that underlisting, properties of durability, cushioning, and tackiness can be imparted while still providing a finished grip of comparatively lesser weight.

Returning to FIG. 3, it will also be appreciated that the grip end portions 16a and 16b may be attached to the center portion 18 using any method of attachment known in the art. As a non-limiting example, a combination of adhesive and friction fit may be used to attach the grip end portions 16a and 16b to the center portion 18. Alternatively, only a friction fit or only an adhesive may be desirable. In still other embodiments, snap fit structures may be used for attaching the grip end portions 16a and 16b to the center portion 18. Even further, the grip end portions 16a and 16b and the center portion 18 may be formed or molded as a unitary construct, i.e., as a single unit using any method of formation or molding known in the art. For example, injection molding, compression molding, extrusion molding, casting, and the like may be used to form the grip end portions 16a and 16b and the center portion 18 as a single unit.

Also, a suitable adhesive may be coated onto an outer surface of the center portion 18 to affix the first layer, such as the layer 22, to the center portion 18. Alternatively, the adhesive may be coated onto an inner surface of the first layer, or onto both surfaces. Still further, the center portion or the first layer may be pre-coated with the adhesive during manufacture. Numerous suitable natural and synthetic adhesives are known in the art. In other embodiments, the center portion and the first layer may be manufactured of compatible materials such that application of sufficient heat and/or pressure cause them to form a bond. The first layer may then be placed on or wrapped around the center portion 18 and received in the receivers 17a and 17b. In this manner, the receivers 17a and 17b may assist in preventing the leakage of adhesive from an area between the first layer and the center portion 18.

A suitable adhesive may also be coated onto an outer surface of the first layer, such as the layer 22, onto an inner surface of the second layer, such as the layer 32, or onto both surfaces to affix the surfaces together. Alternatively, the first layer or the second layer may be pre-coated with the adhesive during manufacture. Again, numerous suitable adhesive substances are known in the art. In yet another embodiment, the layers may be manufactured of compatible materials such that heat and pressure bond them together. The second layer may then be placed over the first layer and received in the receivers 17a and 17b. In this regard, the receivers 17a and 17b may also assist in preventing the leakage of adhesive from an area between the second layer and the first layer.

Turning to FIG. 9, a suitable adhesive may be also used to connect the second layer, such as the layer 92, and the third layer, such as the layer 94, as well as any subsequent layers. In turn, the third and any subsequent layers may then be received in the receivers 17a and 17b, and the receivers 17a and 17b may also assist in preventing the leakage of adhesive from areas between these layers.

Returning to FIG. 3, the lengths L₁ and L₂ of the grip end portions 16a and 16b may be varied to any length necessary to protect the grip ends from damage. In particular embodiments, the grip end portions 16a and 16b may be manufactured to extend along a length of from about 1 millimeter to about 98 millimeters along the gripping end 12 (shown in FIG. 5). In other embodiments, the grip end portions flanges may be manufactured to extend along a length of at least 0.05 inches from an edge of the grip end portions. It will be appreciated that the grip end portions and flanges may also extend various other lengths.

Any material having one or more desired properties of durability, thickness, strength, cushioning, tackiness, and aesthetically pleasing appearance may be used in fabricating the grip end portions 16a and 16b and the receivers 17a and 17b, such as rubber, polymers, latex, natural or synthetic leather, closed cell foams, open cell foams, natural material, synthetic material, or any other material currently used in fabricating grips for sports equipment. The thickness of the grip end portions may be varied in accordance with the needs of the user, i.e. in accordance with the preferred thickness/diameter of the finished grip.

Any material having one or more desired properties of durability, thickness, strength, cushioning, tackiness, and shock absorption required for underlying the layers may be used in fabricating the center portion 18, such as polymers, rubber, latex, natural or synthetic leather, natural material, synthetic material, or any other material currently used in fabricating grips for sports equipment. The thickness of the center portion may also be varied in accordance with the needs of the user, i.e. in accordance with the user's hand size and preferred grip thickness, or the number of layers/inserts to be added thereto.

Also, any material having the desired properties of cushioning, tackiness, aesthetics, durability, thickness, strength, and aesthetically pleasing appearance required for a gripping surface may be used in fabricating any of the layers/inserts, such as polymers (for example polystyrene or polyurethane), closed cell foams, open cell foams, latex, rubber, natural or synthetic leathers, natural material, synthetic material, or any other material currently used in fabricating grips for sports equipment. The thickness of any of the layers may be varied in accordance with the needs of the user, i.e. in accordance with the user's hand size and preferred grip thickness.

In addition, any of the layers may be fabricated of any suitable lightweight material, such as closed cell foams, open cell foams, polymers (for example polystyrene or polyurethane), or synthetic foams. An elongated strip, such as the elongated strip with a locking mechanism as is described in the present inventor's U.S. Pat. No. 6,971,959 for a Grip for Sports Equipment, the entirety of which is incorporated herein by reference, may be used to provide one or more of the recited layers. As illustrated in FIGS. 6-9, the thickness of the layers, such as the layer 62, formed of such a lightweight material may be increased without greatly increasing the weight of the grip, thereby increasing the size of the grip without greatly increasing the weight of the grip. In this manner, an oversized grip of reduced weight in comparison to a conventionally manufactured grip may be provided. Such a reduced weight oversized grip may be desirable for various reasons, such as accommodating the user's hand size and preventing the overlapping of the user's hands without increasing the grip weight (and by extension the weight of the equipment to which the grip is attached) to a weight that inhibits the user's performance in the sport of choice.

As will be discussed below, any of the layers/inserts also may be fabricated of a suitable substantially transparent or translucent material and used protect a design placed on the grip while still allowing visualization of the design. Typically, the substantially transparent layer would be positioned on top of any other layers forming the finished grip. Such a system is described in the present inventor's U.S. Pat. No. 6,718,675 for a Display Grip for Sports Equipment, the entirety of which is incorporated herein by reference.

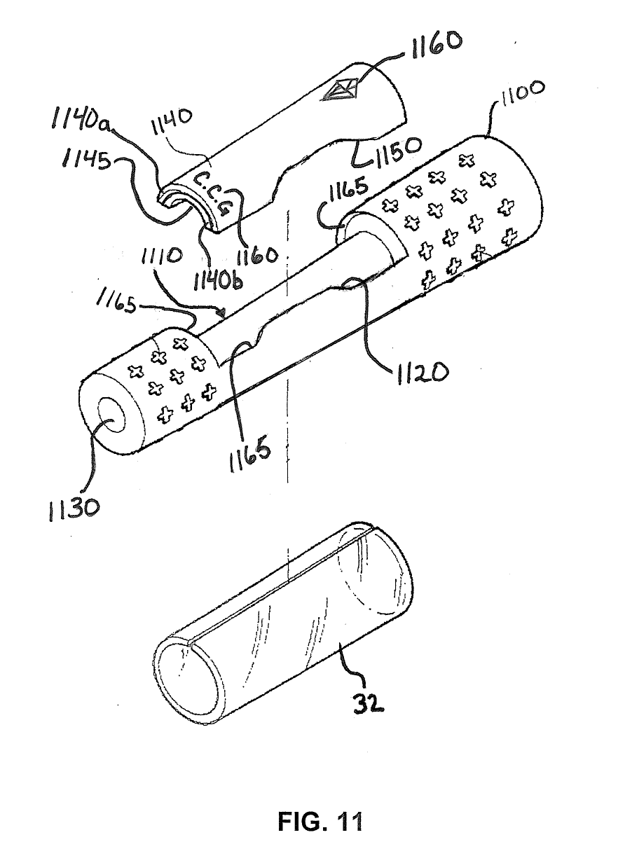

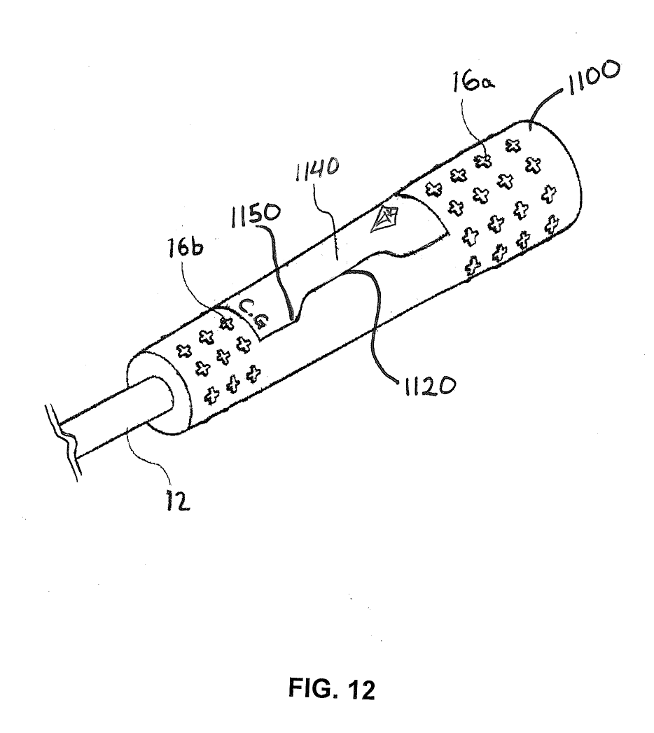

Turning to FIG. 11, there is shown a further embodiment of a grip according to the present disclosure. In that drawing, a grip base (underlisting) 1100 is shown, including a cavity 1110 having an interior perimeter 1120. The grip base 1100 may be unitary as shown in FIG. 11, or may be a multi-piece construction as described above. Cavity 1110 is defined in less than a full circumference of the grip base 1100. It will be appreciated that the term circumference is known in the art to mean the external boundary of a figure or object, and thus is not limiting to a circular or a cylindrical figure. The grip base 1100 further defines a hollow interior 1130 for receiving a gripping end of sporting equipment such as a golf club shaft 12 (see FIG. 12). As will be readily apparent, for a grip base 1100 that is provided as a multi-piece construction, a portion of an upper and a lower edge of cavity 1110 may be defined by an edge of the grip end portions 16a and 16b.

Shown also in the drawing is a layer or insert 1140 having an exterior perimeter 1150 configured to be coincident with, or having substantially the same shape, as the interior perimeter 1120 of the cavity 1110 when assembled. Thus, the insert 1140 disposed in cavity 1110 will cover or overlay less than a full circumference of the grip base 1100. The insert 1140 may include one or more decorative and/or informational designs 1160 disposed thereon. As shown in FIG. 12, when assembled the insert 1130 fits within the interior perimeter of the cavity 1110. Inserts 1140 may be made of the same or different materials as grip base 1100, may be provided with the same or a different texture or “feel” as grip base 1100, may be made of materials having the same or a different color as grip base 1100, and may be made of materials providing the same or different properties of cushioning, tackiness, aesthetics, durability, and strength as grip base 1100. As will be discussed below, this allows significant flexibility in providing not only designs, but also imparting different properties for and to a grip according to the present disclosure.

As non-limiting examples, the grip base 1100 and insert 1140 may be made of any suitable natural or synthetic material as are known in the grip manufacturing arts, such as rubber, cotton, polyurethane, thermoplastic polyolefin, thermoplastic resins, elastomers, and others. Of course, combinations of such materials are contemplated. In turn, particular combinations of materials for grip base 1100/insert 1140 may be selected for desired properties. Without intending any limitation, particular examples of combinations of materials for grip base 1100/insert 1140 could include rubber/polyurethane, thermoplastic polyolefin/polyurethane, thermoplastic resins/polyurethane, elastomers/polyurethane, rubber/elastomers, rubber/thermoplastic polyolefin, thermoplastic polyolefin/elastomers, and others.

Also, inserts 1140 may be unitary as shown in the drawings, or may be provided as two or more discrete layers of material (see layers 1140 a, b in FIG. 11) selected from one or more of the above listed materials. It will be appreciated, as has been discussed in detail above, that this layering method allows altering various properties of the inserts 1140, such as weight, cushioning, tackiness, etc. by using different materials imparting desired properties of cushioning, tackiness, aesthetics, durability, thickness, strength, and aesthetically pleasing appearance.

A substantially transparent top layer 32 (see FIG. 11) may be optionally overlaid over at least a portion of grip base 1100/insert 1140, providing a protective covering that allows visualization of any design element of insert 1140. Top layer 32 may be a planar sheet (FIG. 11), but may also be configured as a hollow sleeve (not shown) which may be slipped or rolled over the assembled grip base 1100/insert 1140. Still further, it is contemplated to form the substantially transparent top layer 32 by applying a liquid polymer to an outer surface of the grip base 1100/insert 1140, and drying to provide a substantially transparent covering film. The liquid polymer may be applied by dipping, rolling, brushing, or spraying, or by any other suitable means for applying a liquid polymer. Particularly in the case where insert 1140 incorporates a decorative or informational design element, but also in any situation where it is desired to provide additional protection to any element of a grip for sporting equipment as disclosed herein, it will be appreciated that this feature allows applying a protective layer 32 whereby such a decorative or informational design element may be viewed without risk of damage from the elements or through use. Of course, a non-transparent top layer 32 is contemplated, for example in embodiments where inserts 1140 are used to form a decorative, informational, or functional design (see discussion below).

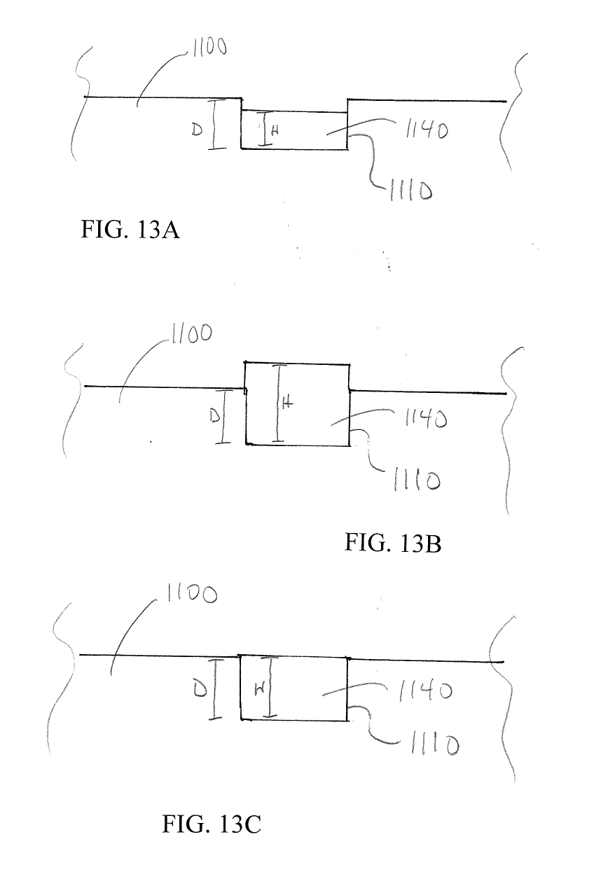

As shown in FIGS. 13a, b, and c, inserts 1140 having a variety of heights H and/or cavities 1110 having a variety of depths D may be provided, whereby when assembled inserts 1140 and cavities 1110 define an indented surface (FIG. 13a), a raised surface (FIG. 13b), and/or a substantially flush surface (FIG. 13c).

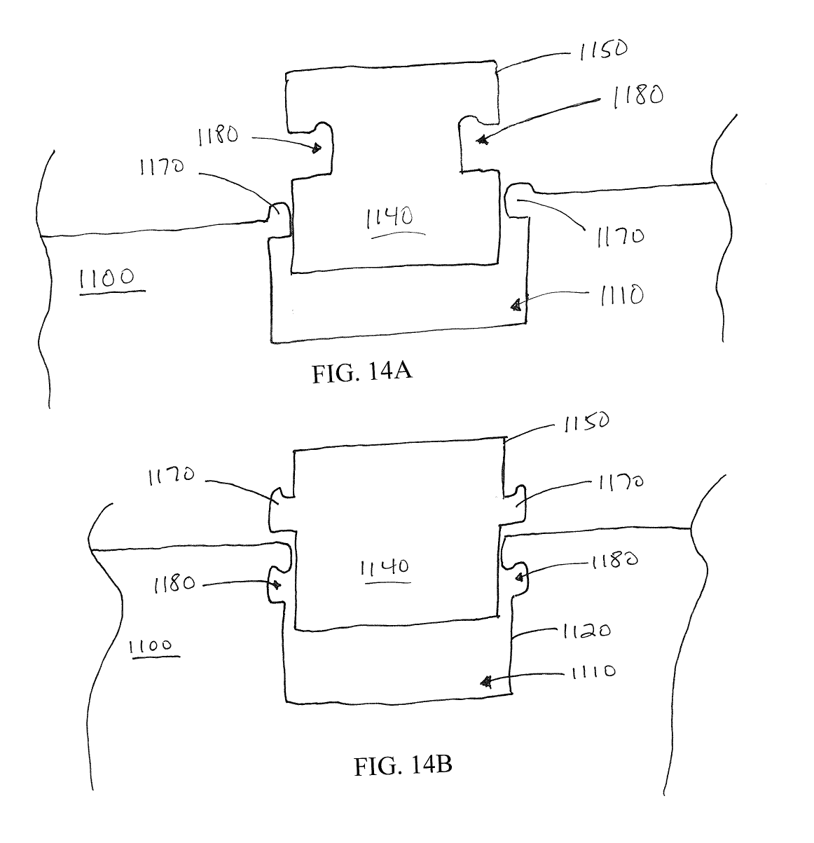

A number of means for retaining inserts 1140 within cavities 1110 are contemplated. For example, any of a number of suitable adhesives are well known to the skilled artisan, and are contemplated for use herein. In another embodiment, the interior perimeter 1120 of cavity 1110 may include a flange 1165 (see FIG. 11) which overlaps at least a portion of an edge of the exterior perimeter 1150 of insert 1140. In yet another embodiment, the insert 1140 may be retained within the cavity 1110 by a friction or interference fit (see FIG. 13). Still further, with reference to FIGS. 14 a-b, in another embodiment a snap fit-type of retention system is contemplated, wherein a cooperating lip 1170 and slot 1180 are provided to assist retention of insert 1140 in cavity 1110. Lip 1170 may be provided on the internal perimeter 1120 of cavity 1110 and slot 1180 may be provided on an external perimeter 1150 of insert 1140. Of course, the obverse relationship is contemplated (FIG. 14b).

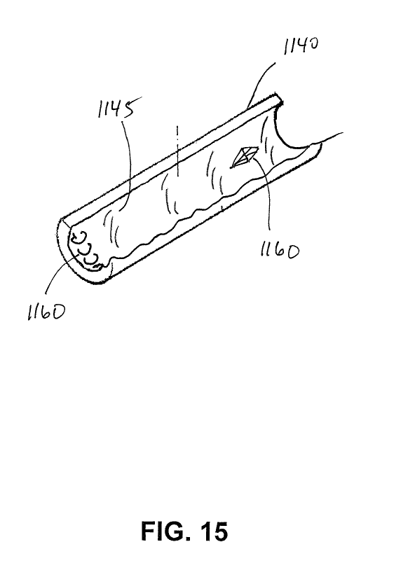

As shown in FIGS. 11 and 12, a design(s) 1160 may be disposed on a top surface of insert 1140. It is further contemplated (see FIG. 15) to provide one or more inserts 1140 made of a substantially transparent or translucent material (see the discussion above of substantially transparent top layer 32), and to dispose a design(s) 1160 on a bottom surface 1145 of insert 1140, whereby when insert 1140 and grip base 1100 are assembled, the design is substantially adjacent a floor of cavity 1110. In that manner, the design(s) 1160 can still be viewed, but are protected by the material of insert 1140.

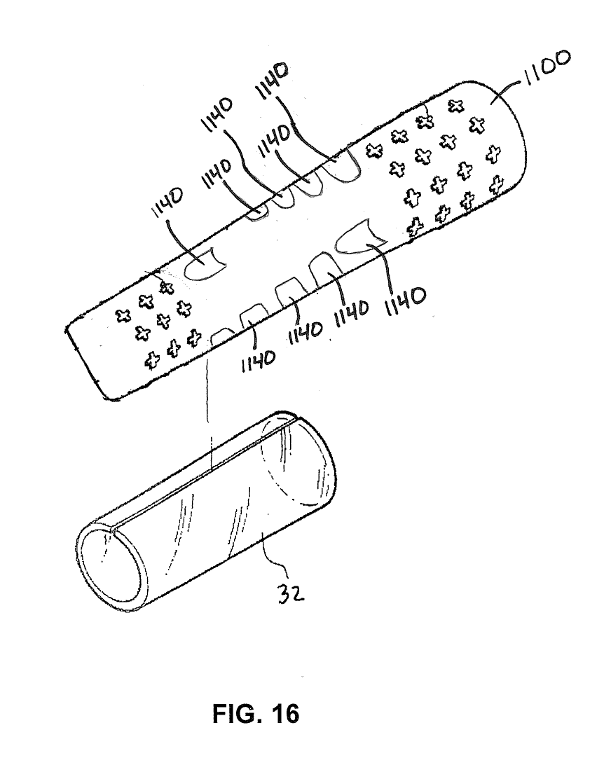

A single insert 1140 may be provided, on which may be disposed a decorative or informational design (see FIGS. 11 and 12). However, it is also contemplated to provide a plurality of inserts 1140, which may include a decorative or informational design, but may also themselves define a decorative, informational, or functional design when assembled on a grip base 1100. As a non-limiting example (see FIG. 16), a plurality of inserts 1140 are provided on a grip base 1100, in combination defining a hand or finger placement guide to assist the user in proper hand/finger placement during use of the assembled grip. Of course, inserts 1140 may be made of a material or materials having different color, texture, cushioning, and/or hardness properties compared to grip base 1100, to further assist the user in visually and/or tactilely determining proper hand and/or finger placement. Still further, the inserts 1140 on grip base 1100 may define (see FIGS. 13a-c) indented surfaces, raised surfaces, flush surfaces, or a combination to provide a further tactile guide for determining proper hand or finger placement during use of the assembled grip. The skilled artisan will appreciate that any number of designs defined by inserts according to the present disclosure are contemplated, including without limitations purely decorative designs, palm or entire hand placement guides, and the like.

Accordingly, the grip of the present invention provides several advantages over conventional grips. One or more of the inserts) 1140, particular layers of materials combined to form the insert(s) 1140, and the grip base 1100 may be made of a material of a lighter or greater weight, of a greater or lesser durability, or having a different texture or “feel,” allowing the grip to be manufactured to varying specifications by varying the nature of the insert(s) 1140 or the grip base 1100. Still further, providing a decorative, instructional, or functional design disposed on a separate insert 1140 allows the grip to be tailored to various desired appearances, weights, or other specifications. while reducing manufacturing cost and complexity. That is, fewer base or core configurations of grip base 1100 may be provided and altered by applying different inserts 1140, thereby providing finished grips having a wide variety of finished appearances and properties at reduced manufacturing cost. At the same time, the grip of the present invention does not compromise the desirable properties of the grip or prevent the display of information on the gripping area.

The foregoing description of a preferred embodiment of the invention has been presented for purposes of illustration and description. It is not intended to be exhaustive or to limit the invention to the precise form disclosed. Obvious modifications or variations are possible in light of the above teachings. For example, an end cap (not shown) may overlay an end of the grip base 1100 on the distal portion of gripping end 12, either before or after the grip 10 of the present invention is installed thereon, using a combination of adhesive and a friction fit as is known in the art. A rib and groove structure as is described in the present inventor's U.S. Pat. No. 6,718,675 for a Display Grip for Sports Equipment may also be used to secure the grip base 1100 to the end cap.

The embodiment described was chosen to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A grip for sporting equipment having a gripping end, comprising:
a base having a hollow interior defining a gripping end receiver and an exterior surface including at least one cavity defined in at least a portion of a thickness thereof, wherein the at least one cavity is defined in less than a full circumference of the base exterior surface; and
at least one insert defining an exterior perimeter substantially coincident with an interior perimeter of the at least one cavity.

2. The grip of claim 1, further including a substantially transparent or translucent top protective layer for overlaying at least a portion of the assembled base exterior surface, at least one cavity, and at least one insert.

3. The grip of claim 1, wherein the at least one insert is retained in the at least one cavity by one or more of a friction fit, a snap fit, an interference fit, a flange defined by an edge of the at least one cavity for overlapping at least a portion of a corresponding edge of the at least one insert, a slot defined in an edge of the at least one cavity for receiving a cooperating lip defined in a corresponding edge of the at least one insert, a slot defined in an edge of the at least one insert for receiving a cooperating lip defined in a corresponding edge of the at least one cavity, and an adhesive.

4. The grip of claim 1, wherein when assembled the at least one insert, the at least one cavity, and the base exterior surface define at least one of a substantially flush top surface, a raised surface, and an indented surface.

5. The grip of claim 1, wherein the assembled at least one insert and at least one cavity define a decorative, informational, or functional design disposed on the base exterior surface.

6. The grip of claim 1, wherein the at least one insert is made of a substantially transparent or translucent material and includes a decorative, informational, or functional design disposed on a bottom surface thereof.

7. The grip of claim 1, wherein the at least one insert includes a decorative, informational, or functional design disposed on a top surface thereof.

8. An article of sporting equipment, comprising a shaft extending between a distal striking end and an opposed gripping end, and a grip positioned on the gripping end, wherein the grip comprises:
a base having a hollow interior defining a gripping end receiver and an exterior surface including at least one cavity defined in at least a portion of a thickness thereof, wherein the at least one cavity is defined in less than a full circumference of the base exterior surface; and
at least one insert defining an exterior perimeter substantially coincident with an interior perimeter of the at least one cavity.

9. The grip of claim 8, further including a substantially transparent or translucent top protective layer for overlaying at least a portion of the assembled base exterior surface, at least one cavity, and at least one insert.

10. The grip of claim 8, wherein the at least one insert is retained in the at least one cavity by one or more of a friction fit, a snap fit, an interference fit, a flange defined by an edge of the at least one cavity for overlapping at least a portion of a corresponding edge of the at least one insert, a slot defined in an edge of the at least one cavity for receiving a cooperating lip defined in a corresponding edge of the at least one insert, a slot defined in an edge of the at least one insert for receiving a cooperating lip defined in a corresponding edge of the at least one cavity, and an adhesive.

11. The grip of claim 8, wherein the at least one insert defines a thickness whereby when assembled the at least one insert, the at least one cavity, and the base exterior surface define at least one of a substantially flush top surface, a raised surface, and an indented surface.

12. The grip of claim 8, wherein the assembled at least one insert and at least one cavity define a decorative, informational, or functional design disposed on the base exterior surface.

13. The grip of claim 8, wherein the at least one insert is made of a substantially transparent or translucent material and includes a decorative, informational, or functional design disposed on a bottom surface thereof.

14. The grip of claim 8, wherein the at least one insert includes a decorative, informational, or functional design disposed on a top surface thereof.

15. A method of placing a decorative, informational, or functional design on a grip for sporting equipment, comprising:
providing a base having a hollow interior defining a gripping end receiver and an exterior surface including at least one cavity defined in at least a portion of a thickness thereof, wherein the at least one cavity is defined in less than a full circumference of the base exterior surface; and
providing at least one design element comprising at least one insert defining an exterior perimeter substantially coincident with an interior perimeter of the at least one cavity.

16. The grip of claim 15, further including providing a substantially transparent or translucent top protective layer for overlaying at least a portion of the assembled base exterior surface, at least one cavity, and at least one insert.

17. The grip of claim 15, including retaining the at least one insert in the at least one cavity by one or more of a friction fit, a snap fit, an interference fit, a flange defined by an edge of the at least one cavity for overlapping at least a portion of a corresponding edge of the at least one insert, a slot defined in an edge of the at least one cavity for receiving a cooperating lip defined in a corresponding edge of the at least one insert, a slot defined in an edge of the at least one insert for receiving a cooperating lip defined in a corresponding edge of the at least one cavity, and an adhesive.

18. The grip of claim 15, including providing at least one insert and at least one cavity whereby when assembled the at least one insert, the at least one cavity, and the base exterior surface define at least one of a substantially flush top surface, a raised surface, and an indented surface.

19. The grip of claim 15, including defining a decorative, informational, or functional design disposed on the base exterior surface by the at least one insert received in the at least one cavity.

20. The grip of claim 15, including providing at least one insert made of a substantially transparent or translucent material and including a decorative, informational, or functional design disposed on a bottom surface thereof.

21. The grip of claim 15, including providing at least one insert including a decorative, informational, or functional design disposed on a top surface thereof.
